(19) United States
(12) Patent Application Publication
(10) Pub. No.: US 2026/0064508 A1
(43) Pub. Date: Mar. 5, 2026

(54) SYSTEMS AND METHODS FOR ENABLING OBSERVABILITY OF BACKEND STORAGE EVENT TO FRONT-END HOST

(71) Applicant: Dell Products L.P., Round Rock, TX (US)

(72) Inventors: Juelong YIN, Shanghai (CN); Yong WANG, Shanghai (CN); Suqi ZHANG, Shanghai (CN); Hao WANG, Shanghai (CN)

(73) Assignee: Dell Products L.P., Round Rock, TX (US)

(21) Appl. No.: 18/891,066

(22) Filed: Sep. 20, 2024

(30) Foreign Application Priority Data
Sep. 4, 2024 (CN) 202411234534.0

(51) Int. Cl. G06F 3/06

(52) U.S. Cl. CPC G06F 11/0727; G06F 3/0653; G06F 3/0673; G06F 11/0793

(57) ABSTRACT

An information handling system may include a processor and a storage monitor comprising a program of instructions embodied in non-transitory computer readable media and configured to, when executed by the processor, read status information from a vital product data (VPD) page stored on a storage volume communicatively coupled to the storage monitor, determine from the status information whether a critical event has occurred at the storage volume that can lead to data loss of data written from the information handling system to the storage volume, and responsive to a determination that the critical event has occurred, perform a remedial action.

### RELATED APPLICATION

The present disclosure claims priority to Chinese Patent Application Serial No. 202411234534.0, filed Sep. 4, 2024, which is incorporated by reference herein in its entirety.

### TECHNICAL FIELD

The present disclosure relates in general to information handling systems, and more particularly to enabling a front-end host to observe a storage event occurring on a backend storage resource.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In modern data centers, remote storage arrays are often used to store data for information handling system hosts. However, it is often not easy for hosts to detect real-time status of arrays. As a result, a host may not be able to do anything to proactively address a sudden interruption of a storage array, which may lead to application downtime or data loss. Thus, it may be desirable to enable a mechanism for a host to receive notification of critical events of the remote array. For example, if the storage array is about to shut down, the host can be made aware of that and take appropriate measures, such as stopping writes, to prevent data loss due to sudden interruptions.

### SUMMARY

In accordance with the teachings of the present disclosure, the disadvantages and problems associated with the use of remote storage arrays may be reduced or eliminated.

In accordance with embodiments of the present disclosure, an information handling system may include a processor and a storage monitor comprising a program of instructions embodied in non-transitory computer readable media and configured to, when executed by the processor, read status information from a vital product data (VPD) page stored on a storage volume communicatively coupled to the storage monitor, determine from the status information whether a critical event has occurred at the storage volume that can lead to data loss of data written from the information handling system to the storage volume, and responsive to a determination that the critical event has occurred, perform a remedial action.

In accordance with these and other embodiments of the present disclosure, a storage array may include one or more storage resources, a vital product data (VPD) page stored on one of the one or more storage resources, and a controller configured to write status information to the VPD page, including information regarding whether a critical event has occurred at the storage array that can lead to data loss of data written from a host information handling system to the storage array.

In accordance with these and other embodiments of the present disclosure, a system may include a storage array, comprising one or more storage resources, a vital product data (VPD) page stored on one of the one or more storage resources, and a controller configured to write status information to the VPD page, including information regarding whether a critical event has occurred at the storage array that can lead to data loss of data written to the storage array. The system may also include an information handling system communicatively coupled to the storage array and comprising a processor and a storage monitor comprising a program of instructions embodied in non-transitory computer readable media and configured to, when executed by the processor, read the status information from the VPD page, determine from the status information whether the critical event has occurred, and responsive to a determination that the critical event has occurred, perform a remedial action.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system including an information handling system and a remote storage array, in accordance with embodiments of the present disclosure; and

FIG. 2 illustrates a flow chart of an example method for enabling a front-end host to observe an event of a backend storage resource.

### DETAILED DESCRIPTION

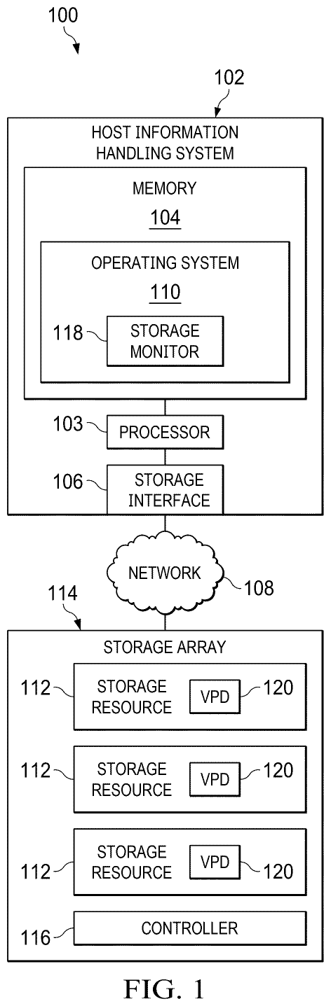

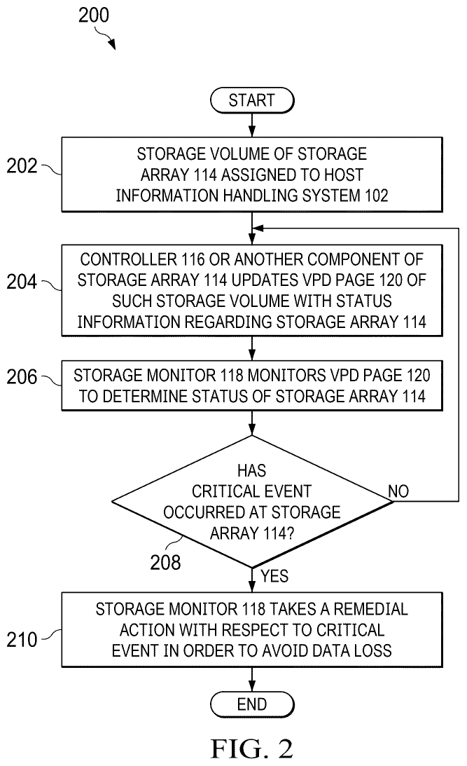

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input and output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, buses, memories, input-output devices and/or interfaces, storage resources, network interfaces, motherboards, electro-mechanical devices (e.g., fans), displays, and power supplies.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (“RAM”) , read-only memory (“ROM”), electrically erasable programmable read-only memory (“EEPROM”), and/or flash memory; as well as communications media such as wires, optical fibers, microwaves, radio waves, and other electromagnetic and/or optical carriers; and/or any combination of the foregoing.

Information handling systems often use an array of physical storage resources (e.g., disk drives), such as a Redundant Array of Independent Disks (“RAID”) , for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.” Implementations of physical storage resource arrays can range from a few physical storage resources disposed in a chassis, to hundreds of physical storage resources disposed in one or more separate storage enclosures.

FIG. 1 illustrates a block diagram of an example system 100 including a host information handling system 102 and a remote storage array 114, in accordance with embodiments of the present disclosure. As shown in FIG. 1, system 100 may include information handling system 102, network 108, and remote storage array 114.

In some embodiments, host information handling system 102 may comprise a server. In these and other embodiments, host information handling system 102 may comprise a personal computer. In other embodiments, host information handling system 102 may comprise a portable computing device (e.g., a laptop, notebook, tablet, handheld, smart phone, personal digital assistant, etc.). As depicted in FIG. 1, host information handling system 102 may include a processor 103, a memory 104 communicatively coupled to processor 103, and a storage interface 106 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage resources 112 of remote storage array 114, and/or another component of host information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to host information handling system 102 is turned off.

As shown in FIG. 1, memory 104 may have stored thereon an operating system 110. Operating system 110 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 110. In addition, operating system 110 may include all or a portion of a network stack for network communication via a network interface. Active portions of operating system 110 may be transferred to memory 104 for execution by processor 103. Although operating system 110 is shown in FIG. 1 as stored in memory 104, in some embodiments operating system 110 may be stored in storage media accessible to processor 103, and active portions of operating system 110 may be transferred from such storage media to memory 104 for execution by processor 103.

As shown in FIG. 1, operating system 110 may include a storage monitor 118. Storage monitor 118 may comprise any suitable program of instructions configured to periodically read vital product data (VPD) from a storage resource 112 of remote storage array 114 in order to determine a status of such storage resource 112 or remote storage array 114 and take appropriate actions based on such status, as set forth in greater detail below.

Storage interface 106 may be communicatively coupled to processor 103 and may include any system, device, or apparatus configured to serve as an interface between processor 103 and storage resources 112 of remote storage array 114 to facilitate communication of data between processor 103 and storage resources 112 in accordance with any suitable standard or protocol. In some embodiments, storage interface 106 may comprise a network interface configured to interface with storage resources 112 located remotely from host information handling system 102.

In addition to processor 103, memory 104, and storage interface 106, host information handling system 102 may include one or more other information handling resources.

Network 108 may be a network and/or fabric configured to couple host information handling system 102 to remote storage array 114. In some embodiments, network 108 may include a communication infrastructure, which provides physical connections, and a management layer, which organizes the physical connections and information handling systems communicatively coupled to network 108. Network 108 may be implemented as, or may be a part of, a SAN or any other appropriate architecture or system that facilitates the communication of signals, data and/or messages (generally referred to as data). Network 108 may transmit data using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 108 and its various components may be implemented using hardware, software, or any combination thereof.

Although FIG. 1 depicts remote storage array 114 having three physical storage resources 112, remote storage array 114 may have any suitable number of physical storage resources 112.

Remote storage array 114 may include any suitable collection of storage resources. In some embodiments, remote storage array 114 may comprise a storage enclosure configured to hold and power storage resources 112. Storage resources 112 may include hard disk drives, magnetic tape libraries, optical disk drives, magneto-optical disk drives, compact disk drives, compact disk arrays, disk array controllers, and/or any other system, apparatus or device operable to store media.

In operation, one or more storage resources 112 may appear to an operating system or virtual machine executing on host information handling system 102 as a single logical storage unit or virtual storage resource 112 (which may also be referred to as a “LUN” or a “volume”). In some embodiments, storage resources 112 making up a logical storage unit may reside in different storage arrays 114.

As shown in FIG. 1, each storage resource 112 may comprise a VPD page 120. A VPD page 120 is typically present on any storage resource, whether a physical disk or a remote array volume. VPD page 120 often contains general metadata information such as vendor name, serial number, worldwide name, and/or other metadata regarding the storage resource. However, in accordance with embodiments of the present disclosure, VPD pages 120 may be leveraged as a notification channel between remote storage array 114 and host information handling system 102, as described in greater detail below.

In addition to storage resources 112, remote storage array 114 may include one or more other information handling resources.

As shown in FIG. 1, remote storage array 114 may include a controller 116. Controller 116 may include any system, apparatus, or device operable to manage the communication of data between host information handling system 102 and storage resources 112 of remote storage array 114. In certain embodiments, controller 116 may provide functionality including, without limitation, disk aggregation and redundancy (e.g., RAID), I/O routing, and error detection and recovery. Controller 116 may also have features supporting shared storage and high availability. In some embodiments, controller 116 may comprise a PowerEdge RAID Controller (PERC) manufactured by Dell Inc.

In addition to host information handling system 102, network 108, remote storage array 114, and network 108, system 100 may include one or more other information handling resources.

In operation, controller 116 or another component of remote storage array 114 may write a relevant status of remote storage array 114 to a VPD page 120 of a storage resource 112 or other storage volume of remote storage array 114. Storage monitor 118 may continuously monitor VPD page 120 over the input/output storage channel between host information handling system 102 and remote storage array 114 by using any suitable software and/or firmware tools. If storage monitor 118 detects a critical event at remote storage array 114 (e.g., remote storage array 114 is about to shut down, remote storage array 114 is experiencing performance issues, or otherwise experiencing an event that could lead to data loss of write data to remote storage array 114), storage monitor 118 may take appropriate remedial measures to avoid data loss.

For example, storage monitor 118 may, in response to detecting the critical event, inject a notification regarding the critical event into an appropriate service of operating system 110. Accordingly, an application executing on operating system 110 may detect the notification and take measures to avoid data loss, such as suspending write operations to remote storage array 114.

Advantageously, by sending the notification through the input/output path, host information handling system 102 is not required to establish a separate communications channel for receiving status notifications. Nor does it require host information handling system 102 to know of the operational structure of remote storage array 114 (e.g., no need to know an application programming interface of remote storage array 114). Instead, host information handling system 102 need only know which VPD page 120 to read for status information.

FIG. 2 illustrates a flow chart of an example method 200 for enabling a front-end host to observe an event of a back-end storage resource, in accordance with embodiments of the present disclosure. According to certain embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, a storage volume of storage array 114 may be assigned to host information handling system 102. At step 204, controller 116 or another component of remote storage array 114 may update VPD page 120 of such storage volume with status information regarding remote storage array 114. In some embodiments, controller 116 or such other component may update such status information continuously.

At step 206, storage monitor 118 may monitor VPD page 120 to determine a status of remote storage array 114. In some embodiments, storage monitor 118 may continuously monitor VPD page 120 to determine a status of remote storage array 114.

At step 208, storage monitor 118 may determine from the monitored status information whether a critical event has occurred at remote storage array 114. In some embodiments, a critical event may include any event that could lead to data loss for write operations to remote storage array 114, such as, for example, remote storage array 114 is about to shut down or remote storage array 114 is experiencing performance issues. If a critical event is present at remote storage array 114, method 200 may proceed to step 210. Otherwise, method 200 may proceed again to step 204.

At step 210, storage monitor 118 may take a remedial action with respect to the critical event in order to avoid data loss. For example, storage monitor 118 may, in response to detecting the critical event, inject a notification regarding the critical event into an appropriate service of operating system 110. Accordingly, an application executing on operating system 110 may detect the notification and take measures to avoid data loss, such as suspending write operations to remote storage array 114.

At conclusion of step 210, method 200 may end.

Although FIG. 2 discloses a particular number of steps to be taken with respect to method 200, it may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using system 100, components thereof or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. An information handling system comprising:
a processor; and
a storage monitor comprising a program of instructions embodied in non-transitory computer readable media and configured to, when executed by the processor:
read status information from a vital product data (VPD) page stored on a remote storage volume communicatively coupled to the storage monitor;
determine from the status information whether a critical event has occurred at the remote storage volume that can lead to data loss of data written from the information handling system to the remote storage volume; and
responsive to a determination that the critical event has occurred, suspend write operations to the remote storage volume.

2. The information handling system of claim 1, wherein the critical event is indicative of an imminent shut down of the storage volume.

3. The information handling system of claim 1, wherein the critical event is indicative of performance issues associated with the storage volume.

4. The information handling system of claim 1, wherein the remedial action comprises injection of a notification regarding the critical event into a service of an operating system of the information handling system.

5. (canceled)

6. A remote storage array configured to communicatively couple to a host information handling system, the remote storage array comprising:
one or more storage resources;
a vital product data (VPD) page stored on one of the one or more storage resources; and
a controller configured to write status information to the VPD page, including information regarding whether a critical event has occurred at the storage array that can lead to data loss of data written from the host information handling system to the storage array.

7. The storage array of claim 6, wherein the critical event is indicative of an imminent shut down of the storage array.

8. The storage array of claim 6, wherein the critical event is indicative of performance issues associated with the storage array.

9. A system comprising:
a remote storage array, comprising:
one or more storage resources;
a vital product data (VPD) page stored on one of the one or more storage resources; and
a controller configured to write status information to the VPD page, including information regarding whether a critical event has occurred at the remote storage array that can lead to data loss of data written to the remote storage array; and
an information handling system communicatively coupled to the remote storage array and comprising:
a processor; and
a storage monitor comprising a program of instructions embodied in non-transitory computer readable media and configured to, when executed by the processor:
read the status information from the VPD page;
determine from the status information whether the critical event has occurred; and
responsive to a determination that the critical event has occurred, suspend write operations to the remote storage array.

10. The system of claim 9, wherein the critical event is indicative of an imminent shut down of the storage array.

11. The system of claim 9, wherein the critical event is indicative of performance issues associated with the storage array.

12. The system of claim 9, wherein the remedial action comprises injection of a notification regarding the critical event into a service of an operating system of the information handling system.

13. (canceled)
